(19) United States
(12) Patent Application Publication
(10) Pub. No.: US 2026/0099230 A1
(43) Pub. Date: Apr. 9, 2026

(54) SYSTEM AND METHODS FOR MULTI-FREQUENCY CAPACITIVE SENSING WITH LOW GROUND MASS (LGM) MITIGATION

(71) Applicant: Synaptics Incorporated, San Jose, CA (US)

(72) Inventor: Tracy Scott Dattalo, Los Gatos, CA (US)

(21) Appl. No.: 19/347,907

(22) Filed: Oct. 2, 2025

Related U.S. Application Data
(60) Provisional application No. 63/703,321, filed on Oct. 4, 2024.

(51) Int. Cl. G06F 3/044; G06F 3/0354

(52) U.S. Cl. CPC G06F 3/0446; G06F 3/03545; G06F 3/03547; G06F 3/0441; G06F 2203/0382; G06F 2203/04104; G06F 2203/04114

(57) ABSTRACT

A system for capacitive touch sensing, includes: a plurality of electrodes corresponding to a sensing region; and a processing system configured to: detect low ground mass (LGM) compensation information based on multiple input objects being present in the sensing region, wherein detecting the LGM compensation information comprises: driving a first transmitter electrode of the plurality of electrodes with a first sensing signal having a first frequency and a second transmitter electrode of the plurality of electrodes with a second sensing signal having a second frequency different from the first frequency, and obtaining resulting signals based on the first and second sensing signals having the first and second frequencies via at least one receiver electrode of the plurality of electrodes; obtain a two-dimensional capacitive touch profile for the multiple input objects in the sensing region; and perform LGM compensation on the two-dimensional capacitive touch profile using the detected LGM compensation information.

### CROSS REFERENCE TO RELATED APPLICATION

The present application claims priority to U.S. Provisional Patent Application No. 63/703,321, filed on Oct. 4, 2024, which is incorporated by reference herein in its entirety.

### FIELD

This present application relates generally to the field of capacitive touch sensor devices, and specifically to mitigating the effects of low ground mass (LGM) during capacitive sensing.

### BACKGROUND

In capacitive touch sensor devices, the quality of the ground connection may significantly impact the sensor's performance. For solid ground connections, where the ground reference of a user and of the sensor is the same, a sensor may accurately detect one or more touch events on the touch sensor device. In other situations, the ground reference of a user may differ significantly from the ground reference of the sensor. Such situations may be termed low ground mass (LGM) conditions.

During LGM conditions, the sensor may detect undesirable parasitic effects which may be difficult to remove. Overall performance of the touch sensor device may be adversely impacted.

### SUMMARY

In an exemplary embodiment, the present application provides a system for capacitive touch sensing. The system includes: a plurality of electrodes corresponding to a sensing region; and a processing system configured to: detect low ground mass (LGM) compensation information based on multiple input objects being present in the sensing region, wherein detecting the LGM compensation information comprises: driving a first transmitter electrode of the plurality of electrodes with a first sensing signal having a first frequency and a second transmitter electrode of the plurality of electrodes with a second sensing signal having a second frequency different from the first frequency, and obtaining resulting signals based on the first and second sensing signals having the first and second frequencies via at least one receiver electrode of the plurality of electrodes; obtain a two-dimensional capacitive touch profile for the multiple input objects in the sensing region; and perform LGM compensation on the two-dimensional capacitive touch profile using the detected LGM compensation information.

In a further exemplary embodiment, the processing system is further configured to: before detecting the LGM compensation information, detect locations of the multiple input objects. In a further exemplary embodiment, the processing system is further configured to: select the first and second transmitter electrodes out of the plurality of electrodes based on the detected locations of the multiple input objects.

In a further exemplary embodiment, the first transmitter electrode is an electrode of a first axis of the sensing region and the second transmitter electrode is a first electrode of a second axis of the sensing region; an intersection between the first and second transmitter electrodes corresponds to a location of a first input object of the multiple input objects; the at least one receiver electrode comprises a first receiver electrode, wherein the first receiver electrode is a second electrode of the second axis of the sensing region; and an intersection between the first transmitter electrode and the first receiver electrode corresponds to a location of a second input object of the multiple input objects. In a further exemplary embodiment, the processing system is configured to drive the first and second transmitter electrodes with the first and second sensing signals simultaneously.

In a further exemplary embodiment, the first transmitter electrode is a first electrode of a first axis of the sensing region and the second transmitter electrode is a second electrode of the first axis of the sensing region; the at least one receiver electrode comprises a first receiver electrode and a second receiver electrode, wherein the first receiver electrode is a first electrode of a second axis of the sensing region, and wherein the second receiver electrode is a second electrode of the second axis of the sensing region; an intersection between the first receiver electrode and the first transmitter electrode corresponds to a location of a first input object of the multiple input objects; and an intersection between the second transmitter electrode and the second receiver electrode corresponds to a location of a second input object of the multiple input objects. In a further exemplary embodiment, the processing system is configured to drive the first and second transmitter electrodes with the first and second sensing signals simultaneously.

In a further exemplary embodiment, the first transmitter electrode is an electrode of a first axis of the sensing region and the second transmitter electrode is a first electrode of a second axis of the sensing region; an intersection between the first and second transmitter electrodes corresponds to a location of a first input object of the multiple input objects; the at least one receiver electrode comprises a receiver electrode, wherein the receiver electrode is a second electrode of the second axis of the sensing region; and the receiver electrode corresponds to a location of a second input object of the multiple input objects. In a further exemplary embodiment, the processing system is configured to drive the first and second transmitter electrodes with the first and second sensing signals simultaneously.

In a further exemplary embodiment, the first transmitter electrode is an electrode of a first axis of the sensing region and the second transmitter electrode is a first electrode of a second axis of the sensing region; the processing system is configured to drive the first and second transmitter electrodes with the first and second sensing signals at different times; while the first transmitter electrode is being driven with the first sensing signal, a plurality of electrodes of the second axis of the sensing region are operated as receiver electrodes; and, while the second transmitter electrode is being driven with the second sensing signal, a plurality of electrodes of the first axis of the sensing region are operated as receiver electrodes.

In a further exemplary embodiment, the two-dimensional capacitive touch profile is a two-dimensional capacitive image of an entire sensing region.

In a further exemplary embodiment, the two-dimensional capacitive touch profile does not include a two-dimensional capacitive image of an entire sensing region; and the two-dimensional capacitive touch profile comprises two-dimensional capacitive images of a first subset of the sensing region corresponding to a first input object of the multiple input objects and of a second subset of the sensing region corresponding to a second input object of the multiple input objects.

In another exemplary embodiment, the present application provides a method for capacitive touch sensing, comprising: detecting, by a processing system, using a plurality of electrodes corresponding to a sensing region, low ground mass (LGM) compensation information based on multiple input objects being present in the sensing region, wherein detecting the LGM compensation information comprises: driving a first transmitter electrode of the plurality of electrodes with a first sensing signal having a first frequency and a second transmitter electrode of the plurality of electrodes with a second sensing signal having a second frequency different from the first frequency; and obtaining resulting signals based on the first and second sensing signals having the first and second frequencies via at least one receiver electrode of the plurality of electrodes; obtaining, by the processing system, a two-dimensional capacitive touch profile for the multiple input objects in the sensing region; and performing, by the processing system, LGM compensation on the two-dimensional capacitive touch profile using the detected LGM compensation information.

In a further exemplary embodiment, the method further comprises: before detecting the LGM compensation information, detecting, by the processing system, locations of the multiple input objects.

In a further exemplary embodiment, the method further comprises: selecting, by the processing system, the first and second transmitter electrodes out of the plurality of electrodes based on the detected locations of the multiple input objects.

In a further exemplary embodiment, the first transmitter electrode is an electrode of a first axis of the sensing region and the second transmitter electrode is a first electrode of a second axis of the sensing region; an intersection between the first and second transmitter electrodes corresponds to a location of a first input object of the multiple input objects; the at least one receiver electrode comprises a first receiver electrode, wherein the first receiver electrode is a second electrode of the second axis of the sensing region; and an intersection between the first transmitter electrode and the first receiver electrode corresponds to a location of a second input object of the multiple input objects.

In a further exemplary embodiment, the first transmitter electrode is a first electrode of a first axis of the sensing region and the second transmitter electrode is a second electrode of the first axis of the sensing region; the at least one receiver electrode comprises a first receiver electrode and a second receiver electrode, wherein the first receiver electrode is a first electrode of a second axis of the sensing region, and wherein the second receiver electrode is a second electrode of the second axis of the sensing region; an intersection between the first receiver electrode and the first transmitter electrode corresponds to a location of a first input object of the multiple input objects; and an intersection between the second transmitter electrode and the second receiver electrode corresponds to a location of a second input object of the multiple input objects.

In a further exemplary embodiment, the first transmitter electrode is an electrode of a first axis of the sensing region and the second transmitter electrode is a first electrode of a second axis of the sensing region; an intersection between the first and second transmitter electrodes corresponds to a location of a first input object of the multiple input objects; the at least one receiver electrode comprises a receiver electrode, wherein the receiver electrode is a second electrode of the second axis of the sensing region; and the receiver electrode corresponds to a location of a second input object of the multiple input objects.

In a further exemplary embodiment, the first transmitter electrode is an electrode of a first axis of the sensing region and the second transmitter electrode is a first electrode of a second axis of the sensing region; the processing system is configured to drive the first and second transmitter electrodes with the first and second sensing signals at different times; while the first transmitter electrode is being driven with the first sensing signal, a plurality of electrodes of the second axis of the sensing region are operated as receiver electrodes; and while the second transmitter electrode is being driven with the second sensing signal, a plurality of electrodes of the first axis of the sensing region are operated as receiver electrodes.

In yet another exemplary embodiment, the present application provides a non-transitory computer-readable medium having processor-executable instructions stored thereon for capacitive touch sensing. The processor-executable instructions, when executed, facilitate performance of the following: detecting, by a processing system, using a plurality of electrodes corresponding to a sensing region, low ground mass (LGM) compensation information based on multiple input objects being present in the sensing region, wherein detecting the LGM compensation information comprises: driving a first transmitter electrode of the plurality of electrodes with a first sensing signal having a first frequency and a second transmitter electrode of the plurality of electrodes with a second sensing signal having a second frequency different from the first frequency, and obtaining resulting signals based on the first and second sensing signals having the first and second frequencies via at least one receiver electrode of the plurality of electrodes; obtaining, by the processing system, a two-dimensional capacitive touch profile for the multiple input objects in the sensing region; and performing, by the processing system, LGM compensation on the two-dimensional capacitive touch profile using the detected LGM compensation information.

### BRIEF DESCRIPTION OF THE DRAWINGS

So that the manner in which features of the present application can be understood in detail, a particular description may be had by reference to embodiments, some of which are illustrated in the appended drawings. It is to be noted, however, that the appended drawings illustrate only exemplary embodiments, and are therefore not to be considered limiting of inventive scope, as the present application may admit to other effective embodiments.

FIG. 1 depicts a block diagram of an exemplary input device.

FIG. 2 illustrates one of various examples of a touch sensor device with multiple electrodes during a multi-point touch event.

FIG. 3 illustrates another example of a touch sensor device with multiple electrodes during a multi-point touch event.

FIG. 4 illustrates another example of a touch sensor device with multiple electrodes during a multi-point touch event.

FIG. 5 illustrates one of various examples of a transcapacitance profile of a touch sensor device while driving an electrode during a multi-point touch event.

FIG. 6 illustrates another example of a transcapacitance profile of a touch sensor device while driving an electrode during a multi-point touch event.

FIG. 7 illustrates one of various examples of a circuit for driving one or more electrodes of a touch sensor device, along with a circuit model for capacitive couplings associated with the presence of a first finger.

FIG. 8 illustrates one of various examples of a generalized circuit model of a touch sensor device.

FIG. 9 illustrates an example of a flowchart corresponding to a process for capacitive sensing according to an exemplary embodiment of the present application.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The following detailed description is exemplary in nature and is not intended to limit the invention or the application and uses of the invention. Furthermore, there is no intention to be bound by any expressed or implied theory presented in the preceding technical field, background, brief summary, brief description of drawings, or the following detailed description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Exemplary embodiments of the present application provide sensor driving schemes which improve sensor performance under LGM conditions.

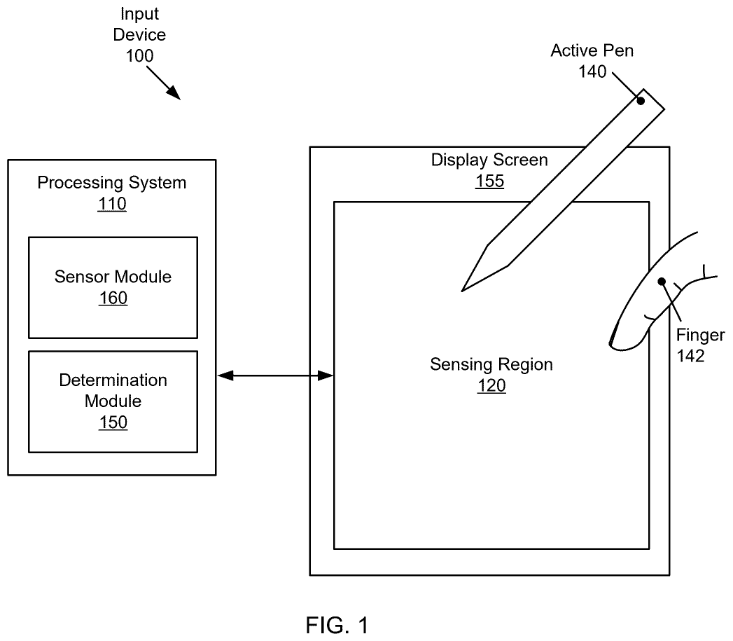

FIG. 1 is a block diagram of an exemplary input device 100 for which exemplary embodiments of the present application are applicable. The input device 100 may be configured to provide input to an electronic system. As used in this document, the term “electronic system” (or “electronic device”) broadly refers to any system capable of electronically processing information. Some non-limiting examples of electronic systems include personal computers, such as desktop computers, laptop computers, netbook computers, tablets, web browsers, e-book readers, and personal digital assistants (PDAs). Additional example electronic systems include composite input devices, such as physical keyboards that include input device 100 and separate joysticks or key switches. Further example electronic systems include peripherals, such as data input devices (including remote controls and mice), and data output devices (including display screens and printers). Other examples include remote terminals, kiosks, and video game machines (e.g., video game consoles, portable gaming devices, and the like). Other examples include communication devices (including cellular phones, such as smart phones), and media devices (including recorders, editors, and players such as televisions, set-top boxes, music players, digital photo frames, and digital cameras). Additionally, the electronic system may be a host or a slave to the input device.

In FIG. 1, the input device 100 is shown as a touch sensor device (e.g., “touchpad” or a “touch sensor”) configured to sense input provided by one or more input objects in a sensing region 120. Example input objects include styli, an active pen 140, and fingers 142. Further, which particular input objects are in the sensing region may change over the course of one or more gestures. For example, a first input object may be in the sensing region to perform the first gesture, subsequently, the first input object and a second input object may be in the above surface sensing region, and, finally, a third input object may perform the second gesture. To avoid unnecessarily complicating the description, the singular form of input object is used and refers to all of the above variations.

The sensing region 120 encompasses any space above, around, in and/or near the input device 100 in which the input device 100 is able to detect user input (e.g., user input provided by one or more input objects). The sizes, shapes, and locations of particular sensing regions may vary widely from embodiment to embodiment.

The input device 100 may use any combination of sensor components and sensing technologies to detect user input in the sensing region 120. The input device 100 includes one or more sensing elements for detecting user input. The sensing elements may be capacitive.

In some capacitive implementations of the input device 100, voltage or current is applied to create an electric field. Nearby input objects cause changes in the electric field and produce detectable changes in capacitive coupling that may be detected as changes in voltage, current, or the like.

Some capacitive implementations utilize arrays or other regular or irregular patterns of capacitance sensing elements to create electric fields. In some capacitive implementations, separate sensing elements may be ohmically shorted together to form larger sensor electrodes. Some capacitive implementations utilize resistive sheets, which may be uniformly resistive.

Some capacitive implementations utilize “self capacitance” (or “absolute capacitance”) sensing methods based on changes in the capacitive coupling between sensor electrodes and an input object. In various embodiments, an input object near the sensor electrodes alters the electric field near the sensor electrodes, thus changing the measured capacitive coupling. In one implementation, an absolute capacitance sensing method operates by modulating sensor electrodes with respect to a reference voltage (e.g., system ground), and by detecting the capacitive coupling between the sensor electrodes and input objects. The reference voltage may by a substantially constant voltage or a varying voltage and in various embodiments; the reference voltage may be system ground. Measurements acquired using absolute capacitance sensing methods may be referred to as absolute capacitive measurements.

Some capacitive implementations utilize “mutual capacitance” (or “transcapacitance”) sensing methods based on changes in the capacitive coupling between sensor electrodes. In various embodiments, an input object near the sensor electrodes alters the electric field between the sensor electrodes, thus changing the measured capacitive coupling. In one implementation, a mutual capacitance sensing method operates by detecting the capacitive coupling between one or more transmitter sensor electrodes (also “transmitter electrodes” or “transmitter”) and one or more receiver sensor electrodes (also “receiver electrodes” or “receiver”). Transmitter sensor electrodes may be modulated relative to a reference voltage (e.g., system ground) to transmit transmitter signals. Receiver sensor electrodes may be held substantially constant relative to the reference voltage to facilitate receipt of resulting signals. The reference voltage may be a substantially constant voltage and in various embodiments; the reference voltage may be system ground.

In some embodiments, transmitter sensor electrodes and receiver sensor electrodes may both be modulated. The transmitter electrodes may be modulated relative to the receiver electrodes to transmit transmitter signals and to facilitate receipt of resulting signals. A resulting signal may include effect(s) corresponding to one or more transmitter signals, and/or to one or more sources of environmental interference (e.g., other electromagnetic signals). The effect(s) may be the transmitter signal, a change in the transmitter signal caused by one or more input objects and/or environmental interference, or other such effects. Sensor electrodes may be dedicated transmitters or receivers or may be configured to both transmit and receive. Measurements acquired using mutual capacitance sensing methods may be referred to as mutual capacitance measurements.

In FIG. 1, a processing system 110 is shown as part of the input device 100. The processing system 110 is configured to operate the hardware of the input device 100 to detect input in the sensing region 120. The processing system 110 includes parts of or all of one or more integrated circuits (ICs) and/or other circuitry components. For example, a processing system 110 for a mutual capacitance sensor device may include transmitter circuitry configured to transmit signals with transmitter sensor electrodes, and/or receiver circuitry configured to receive signals with receiver sensor electrodes. Further, a processing system 110 for an absolute capacitance sensor device may include driver circuitry configured to drive absolute capacitance signals onto sensor electrodes, and/or receiver circuitry configured to receive signals with those sensor electrodes. In one or more embodiments, a processing system 110 for a combined mutual and absolute capacitance sensor device may include any combination of the above described mutual and absolute capacitance circuitry. A processing system 110 may further include receiver circuitry configured to receive signals emitted by a different source, e.g., an active pen 140. The signals by the active pen 140 may be received by the receiver sensor electrodes, while transmit signals are not necessarily emitted by transmitter sensor electrodes.

In some embodiments, the processing system 110 also includes electronically-readable instructions, such as firmware code, software code, and/or the like. In some embodiments, components composing the processing system 110 are located together, such as near sensing element(s) of the input device 100. In other embodiments, components of processing system 110 are physically separate with one or more components close to the sensing element(s) of the input device 100, and one or more components elsewhere. For example, the input device 100 may be a peripheral coupled to a computing device, and the processing system 110 may include software configured to run on a central processing unit of the computing device and one or more ICs (perhaps with associated firmware) separate from the central processing unit. As another example, the input device 100 may be physically integrated in a mobile device, and the processing system 110 may include circuits and firmware that are part of a main processor of the mobile device. In some embodiments, the processing system 110 is dedicated to implementing the input device 100. In other embodiments, the processing system 110 also performs other functions, such as operating display screens 155, driving haptic actuators, etc.

The processing system 110 may be implemented as a set of modules that handle different functions of the processing system 110. Each module may include circuitry, firmware, software, or a combination thereof. In various embodiments, different combinations of modules may be used. For example, as shown in FIG. 1, the processing system 110 may include a determination module 150 and a sensor module 160. The determination module 150 may include functionality to determine when at least one input object is in a sensing region, signal to noise ratio, positional information of an input object, a gesture, an action to perform based on the gesture, a combination of gestures or other information, and/or other operations. For example, the determination module 150 may be implemented in the form of a controller and/or processing circuitry.

The sensor module 160 may include functionality to drive the sensing elements to transmit transmitter signals and receive the resulting signals. For example, the sensor module 160 may include sensory circuitry that is coupled to the sensing elements. The sensor module 160 may include, for example, a transmitter module and a receiver module. The transmitter module may include transmitter circuitry that is coupled to a transmitting portion of the sensing elements. The receiver module may include receiver circuitry coupled to a receiving portion of the sensing elements and may include functionality to receive the resulting signals. The receiver module of the sensor module 160 may receive resulting signals from sensor electrodes in the electrode pattern using a capacitive sensing signal having a sensing frequency, e.g., generated by the transmitter module. The resulting signals may include desired signals, such as active pen data or signal components caused by an input object being in proximity to the electrode pattern, or undesired signals, such as noise or interference. As will be described in greater detail below, the sensor module 160 may perform one or more demodulation operations on the resulting signal.

Although FIG. 1 shows a determination module 150 and a sensor module 160, alternative or additional modules may exist in accordance with one or more embodiments. Such alternative or additional modules may correspond to distinct modules or sub-modules than one or more of the modules discussed above. Example alternative or additional modules include hardware operation modules for operating hardware such as sensor electrodes and display screens 155, data processing modules for processing data such as sensor signals and positional information, reporting modules for reporting information, and identification modules configured to identify gestures, such as mode changing gestures, and mode changing modules for changing operation modes. Further, the various modules may be combined in separate integrated circuits. For example, a first module may be comprised at least partially within a first integrated circuit and a separate module may be comprised at least partially within a second integrated circuit. Further, portions of a single module may span multiple integrated circuits. In some embodiments, the processing system as a whole may perform the operations of the various modules.

In some embodiments, the processing system 110 responds to user input (or lack of user input) in the sensing region 120 directly by causing one or more actions. Example actions include changing operation modes, as well as graphical user interface (GUI) actions such as cursor movement, selection, menu navigation, and other functions. In some embodiments, the processing system 110 provides information about the input (or lack of input) to some part of the electronic system (e.g., to a central processing system of the electronic system that is separate from the processing system 110, if such a separate central processing system exists). In some embodiments, some part of the electronic system processes information received from the processing system 110 to act on user input, such as to facilitate a full range of actions, including mode changing actions and GUI actions.

In some embodiments, the input device 100 includes a touch screen interface, and the sensing region 120 overlaps at least part of an active area of a display screen 155. For example, the input device 100 may include substantially transparent sensor electrodes overlaying the display screen and provide a touch screen interface for the associated electronic system. The display screen may be any type of dynamic display capable of displaying a visual interface to a user and may include any type of light emitting diode (LED), organic LED (OLED), cathode ray tube (CRT), liquid crystal display (LCD), plasma, electroluminescence (EL), or other display technology. The input device 100 and the display screen 155 may share physical elements. For example, some embodiments may utilize some of the same electrical components for displaying and sensing. In various embodiments, one or more display electrodes of a display device may be configured for both display updating and input sensing. As another example, the display screen 155 may be operated in part or in total by the processing system 110.

FIG. 1 shows merely one exemplary configuration of components, and it will be appreciated that other configurations may be used without departing from the scope of the application. For example, various components may be combined to create a single component. As another example, the functionality performed by a single component may be performed by two or more components. Further, while a configuration for touch sensing is described, other parameters such as force may be sensed.

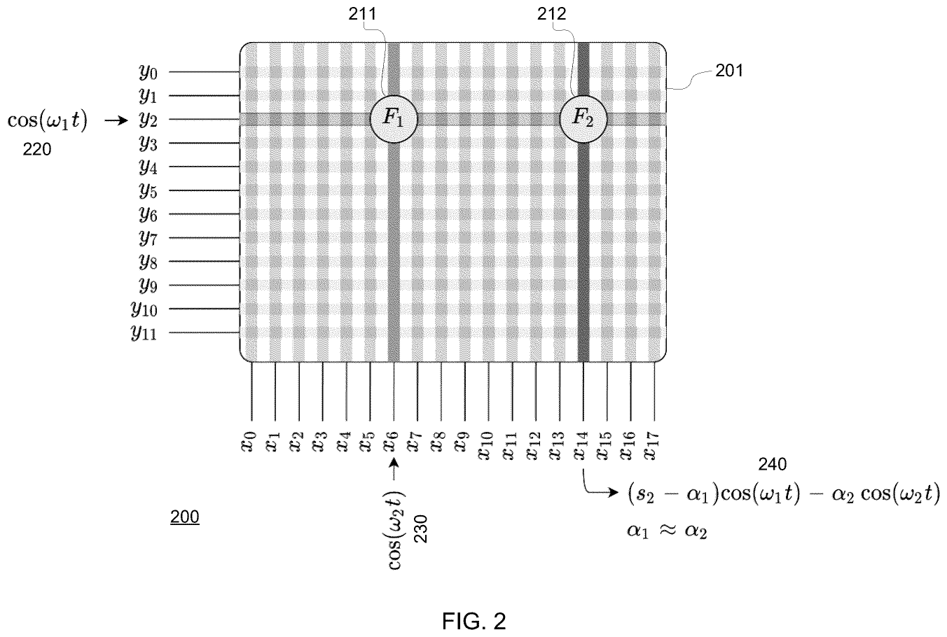

FIG. 2 illustrates one of various examples of a touch sensor device 200 with multiple electrodes during a multi-point touch event.

Touch sensor device 200 may include a sensing region 201 having a plurality of electrodes. The example illustrated in FIG. 2 includes horizontal electrodes y₀ through y₁₁ and vertical electrodes x₀ through x₁₇, but this is not intended to be limiting. Other examples may include a different number of electrodes and may include electrodes in a different orientation or direction.

A first finger F₁ may touch down onto touch sensor device 200 at location 211. A second finger F₂ may touch down onto touch sensor device 200 at location 212. A first signal 220 may be driven onto electrode y₂. First signal 220 may be a sinusoidal signal cos(ω₁t). In other implementations, first signal 220 may also be a different time-domain signal. A second signal 230 may be driven onto electrode x₆. Second signal 230 may be a sinusoidal signal cos(ω₂t). In other implementations, second signal 230 may also be a different time-domain signal not specifically mentioned. The values ω₁ and ω₂ represent distinct frequencies which are able to be transmitted and decoded separately and simultaneously. The distinct frequencies may be orthogonal frequencies.

Touch sensor device 200 may detect a signal 240 via electrode x₁₄ which includes a signal s₂ based on second finger F₂ touching down at location 212 and may further include parasitic effects of first finger F₁. The signal 240 detected on electrode x₁₄ (in response to the sensing signals driven onto x6 and y2) may be represented as (s₂−α₁)cos(ω₁t)−α₂ cos(ω₂t), where α₁ and α₂ represent the parasitic effects of first finger F₁.

It will be appreciated that although FIG. 2 shows electrodes in a bars-and-stripes configuration, the principles discussed herein are applicable to other electrode arrangements.

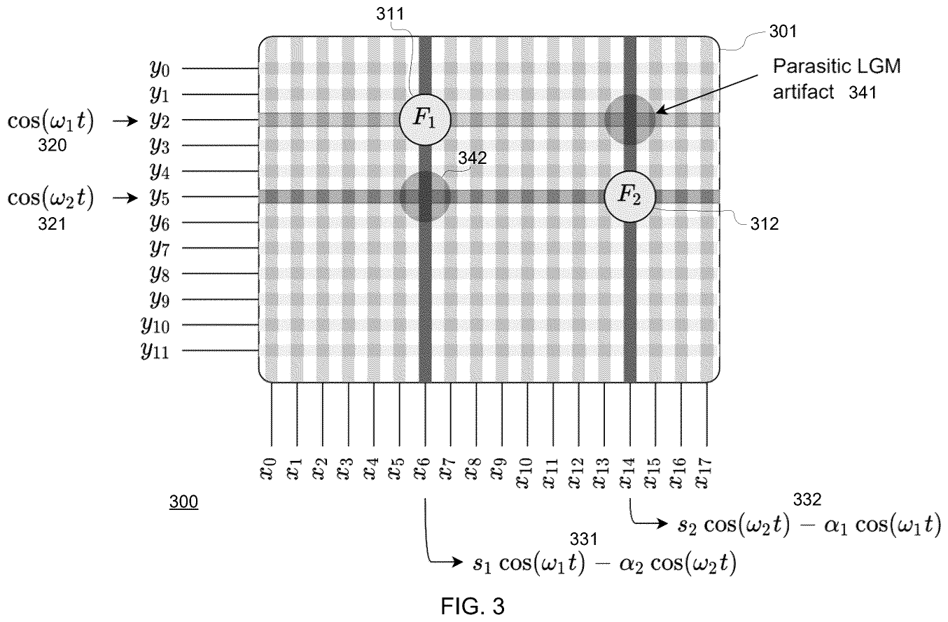

FIG. 3 illustrates another example of a touch sensor device 300 with multiple electrodes during a multi-point touch event.

Touch sensor device 300 may include a sensing region 301 having a plurality of electrodes. The example illustrated in FIG. 3 includes horizontal electrodes y₀ through y₁₁ and vertical electrodes x₀ thru x₁₇, but this is not intended to be limiting. Other examples may include a different number of electrodes and may include electrodes in a different orientation or direction.

A first finger F₁ may touch down onto touch sensor device 300 at location 311. A second finger F₂ may touch down onto touch sensor device 300 at location 312. A first signal 320 may be driven onto electrode y₂. First signal 320 may be a sinusoidal signal cos(ω₁t). In other implementations, first signal 320 may be a different time-domain signal. A second signal 321 may be driven onto electrode y₅. Second signal 321 may be a sinusoidal signal cos(ω₂t). In other implementations, second signal 321 may be a different time-domain signal. The values ω₁ and ω₂ represent distinct frequencies, which may be orthogonal frequencies.

Touch sensor device 300 may detect a signal 331 at vertical electrode x₆ based on first finger F₁ touching down at location 311. The signal 331 detected at vertical electrode x₆ may also include a parasitic effect of second finger F₂ touching down at location 312. The signal 331 detected at vertical electrode x₆ may be represented as s₁ cos(ω₁t)−α₂ cos(ω₂t), where s₁ cos(ω₁t) represents the desired response of first finger F₁ touching down at location 311, and −α₂ cos(ω₂t) represents the parasitic effect of second finger F₂ touching down at location 312.

Touch sensor device 300 may detect a signal 332 at vertical electrode x₁₄ based on second finger F₂ touching down at location 312. The signal 332 detected at vertical electrode x₁₄ may also include a parasitic effect of first finger F₁ touching down at location 311. The signal 332 detected at vertical electrode x₁₄ may be represented as s₂ cos(ω₂t)−α₁ cos(ω₁t), where s₂ cos(ω₂t) represents the desired response of second finger F₂ touching down at location 312, and −α₁ cos(ω₁t) represents the parasitic effect of first finger F₁ touching down at location 311.

The values of LGM parameters α₁ and α₂ associated with frequencies ω₁ and ω₂ in the example illustrated in FIG. 3 may depend on the size of first finger F₁ and second finger F₂, and may depend on the capacitive couplings between first finger F₁ and second finger F₂ and the excitation electrodes. The value of may be termed a first parasitic response and the value x₂ may be termed a second parasitic response.

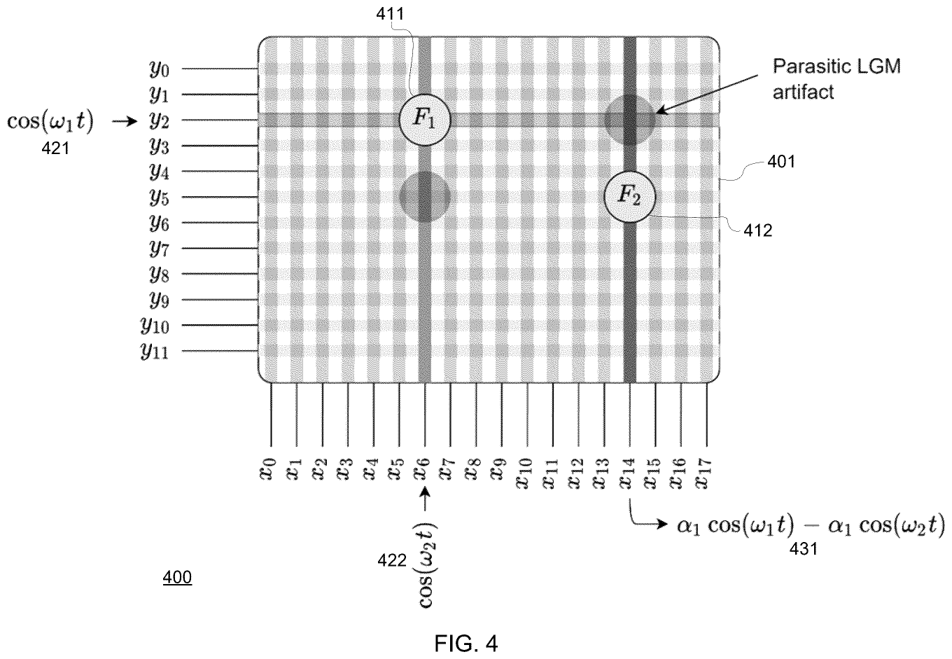

FIG. 4 illustrates another example of a touch sensor device 400 with multiple electrodes during a multi-point touch event.

Touch sensor device 400 may include a sensing region 401 having a plurality of electrodes. The example illustrated in FIG. 4 includes horizontal electrodes y₀ through y₁₁ and vertical electrodes x₀ through x₁₇, but this is not intended to be limiting. Other examples may include a different number of electrodes and may include electrodes in a different orientation or direction.

A first finger F₁ may touch down onto touch sensor device 400 at location 411. A second finger F₂ may touch down onto touch sensor device 400 at location 412. A first signal 421 may be driven onto electrode y₂. First signal 421 may be a sinusoidal signal cos(ω₁t). In other implementations, first signal 421 may be a different time-domain signal. A second signal 422 may be driven onto electrode x₆. Second signal 422 may be a sinusoidal signal cos(ω₂t). In other implementations, second signal 422 may be a different time-domain signal. The values ω₁ and ω₂ represent distinct frequencies, which may be orthogonal frequencies.

Touch sensor device 400 may detect a signal 431 at vertical electrode x₁₄ based on second finger F₂ touching down at location 412. The signal 431 detected at vertical electrode x₁₄ may also include a parasitic effect of first finger F₁ touching down at location 411. The signal 431 detected at vertical electrode x₁₄ may be represented as α₁ cos(ω₁t)−α₁ cos(ω₂t). Since the two stimulated electrodes y₂ and x₆ do not intersect with second finger F₂ at location 412, the signal 431 detected at vertical electrode x₁₄ is purely due to low-ground mass (LGM) effects from first finger F₁ at location 411. The response α₁ cos(ω₁t) represents the parasitic response of first finger F₁ touching down at location 411 and interacting with the signal 421 driven onto electrode y₂, and −α₁ cos(ω₂t) represents the parasitic effect of first finger F₁ touching down at location 411 and interacting with the signal 422 driven onto electrode x₆.

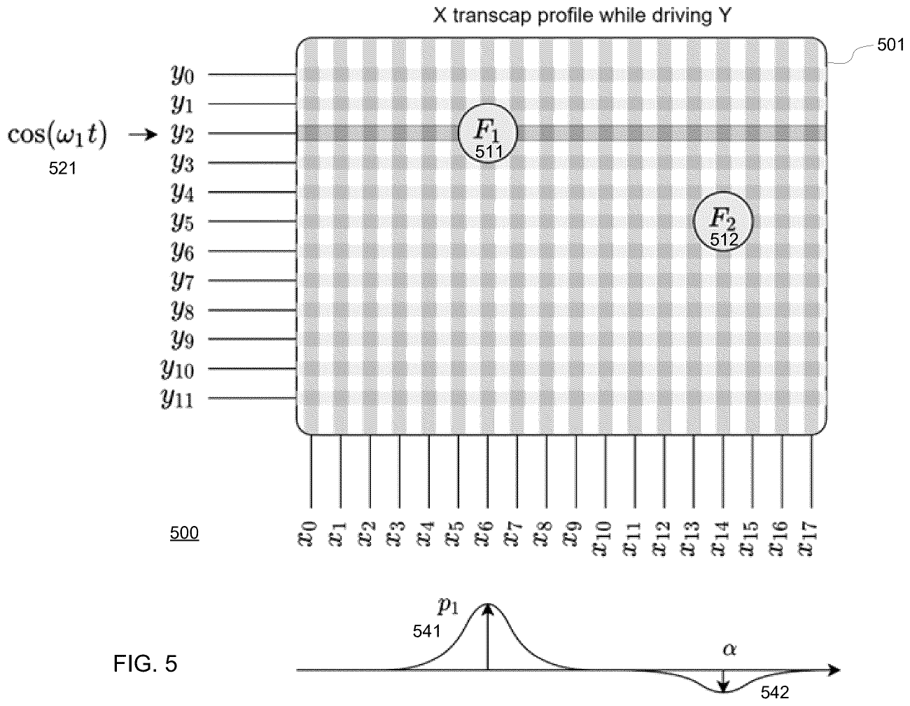

FIG. 5 illustrates one of various examples of a transcapacitance profile of a touch sensor device 500 while driving an electrode during a multi-point touch event.

Touch sensor device 500 may include a sensing region 501 having a plurality of electrodes. The example illustrated in FIG. 5 includes horizontal electrodes y₀ through y₁₁ and vertical electrodes x₀ through x₁₇, but this is not intended to be limiting. Other examples may include a different number of electrodes and may include electrodes in a different orientation or direction.

A first finger F₁ may touch down onto touch sensor device 500 at location 511. A second finger F₂ may touch down onto touch sensor device 500 at location 512. A first signal 521 may be driven onto electrode y₂.

A signal may be sensed at vertical electrodes x₀ through x₁₇. At electrode x₆, a positive peak may be detected as shown at 541. The height of this peak may be attenuated due to the LGM effect and the presence of second finger F₂. At electrode x₁₄, a negative peak may be detected at 542 based on the LGM effect and the presence of second finger F₂ at location 512.

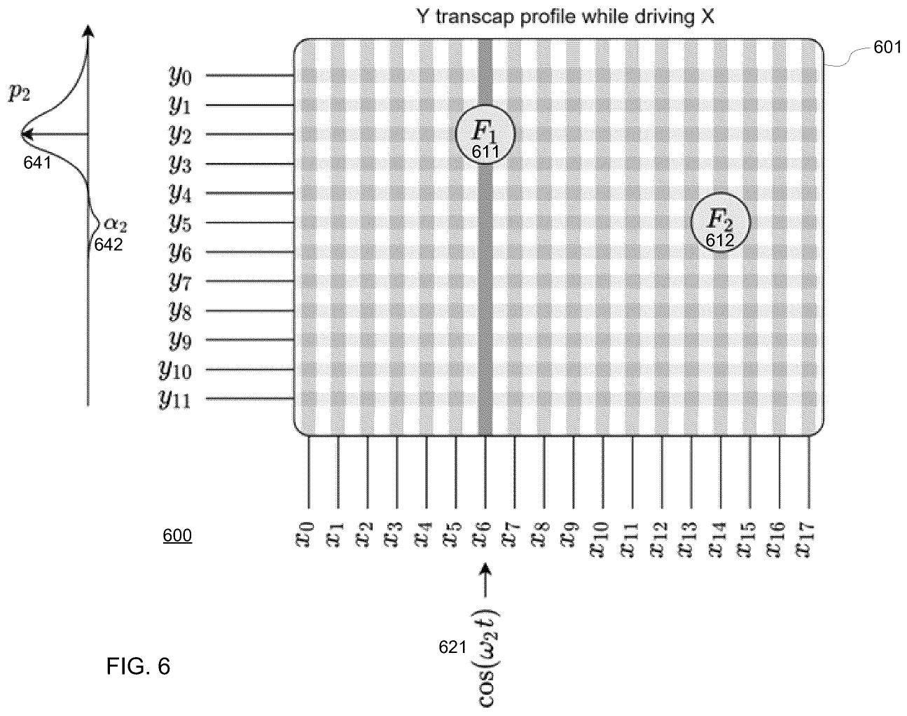

FIG. 6 illustrates another example of a transcapacitance profile of a touch sensor device 600 while driving an electrode during a multi-point touch event.

Touch sensor device 600 may include a sensing region 601 having a plurality of electrodes. The example illustrated in FIG. 6 includes horizontal electrodes y₀ through y₁₁ and vertical electrodes x₀ through x₁₇, but this is not intended to be limiting. Other examples may include a different number of electrodes and may include electrodes in a different orientation or direction.

A first finger F₁ may touch down onto touch sensor device 600 at location 611. A second finger F₂ may touch down onto touch sensor device 600 at location 612. A first signal 621 may be driven onto electrode x₆.

A signal may be sensed at horizontal electrodes y₀ through y₁. At electrode y₂, a positive peak may be detected as shown at 641. The height of this peak may be attenuated due to the LGM effect and the presence of second finger F₂. At electrode y₅, a negative peak may be detected at 642 based on the LGM effect and the presence of second finger F₂ at location 612.

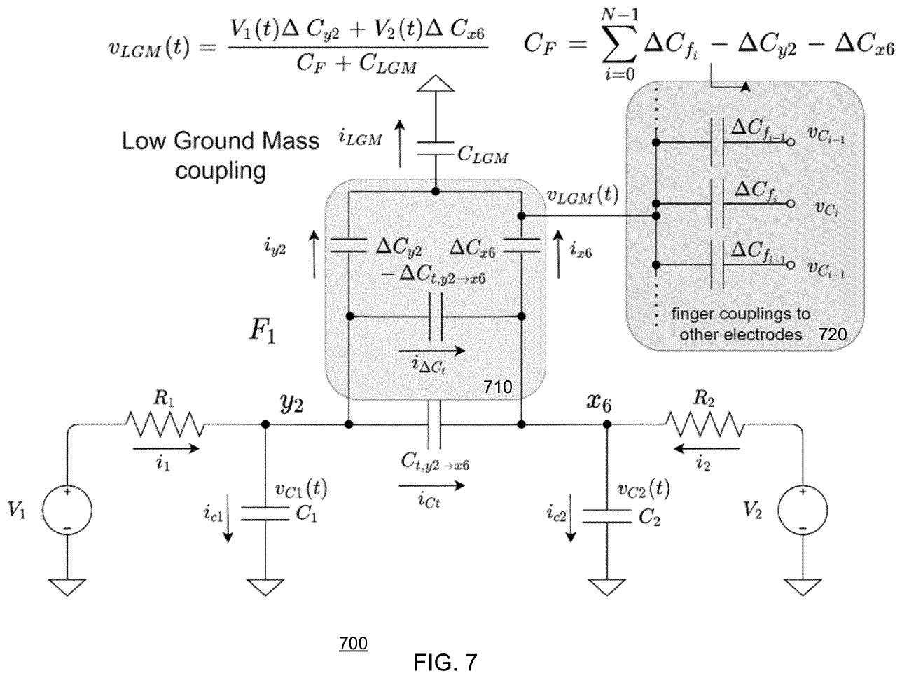

FIG. 7 illustrates one of various examples of a circuit 700 for driving one or more electrodes of a touch sensor device, along with a circuit model for capacitive couplings associated with the presence of a first finger F₁.

Voltage source V₁ may generate a voltage and may create electrode voltage y₂. Electrode voltage y₂ may drive electrode y₂ as described and illustrated in reference to FIG. 2. Resistor R₂ and capacitor C₂ may filter and attenuate the output of voltage source V₁. Voltage source V₁, resistor R₁, and capacitor C₁ may generate a voltage for any electrode of a touch sensor device.

Voltage source V₂ may generate a voltage and may create electrode voltage x₆. Electrode voltage x₆ may drive electrode x₆ as described and illustrated in reference to FIG. 2. Resistor R₂ and capacitor C₂ may filter and attenuate the output of voltage source V₂. Voltage source V₂, resistor R₂, and capacitor C₂ may generate a voltage for any electrode of a touch sensor device.

Circuit 710 illustrates capacitive couplings between first finger F₁, electrode y₂ and electrode x₆. The top plate of capacitor ΔC_{y2} and ΔCₓ₆ are connected to the LGM node. Circuit 720 illustrates capacitive couplings from first finger F₁ to all other electrodes. All other electrodes are modelled as capacitors between the LGM node and ground.

In the model of FIG. 7, the LGM voltage V_{LGM}(t) is a linear combination of the y₂ and x₆ couplings. Although the C_{LGM} capacitance is unknown and the LGM voltage may not be computed, a sensor response due to a second finger at electrode x₁₄ (for example, as shown in FIG. 2) may be measured. The measured charge can be denoted as V_{LGM}(t)DCₓ₁₄. Consequently,

$${q}_{x 14} = {v}_{LGM} ( t ) Δ {C}_{x 14} = \frac{{V}_{1} ( t ) Δ {C}_{y 2} + {V}_{2} ( t ) Δ {C}_{x 6}}{{C}_{F} + {C}_{LGM}} Δ {C}_{x 14} \qquad ( 1 )$$

$$Accordingly ,$$

$${α}_{1} = \frac{Δ {C}_{x 14} Δ {C}_{y 2}}{{C}_{F} + {C}_{LGM}} \qquad ( 2 )$$

$${α}_{2} = \frac{Δ {C}_{x 14} Δ {C}_{x 6}}{{C}_{F} + {C}_{LGM}}$$

Given that each voltage is at a different frequency, the values of α₁ and α₂ may be determined based on the following equation:

$${q}_{x 14} = {V}_{LGM} ( t ) Δ {C}_{x 14} = {α}_{1} {V}_{1} ( t ) + {α}_{2} {V}_{2} ( t ) \qquad ( 3 )$$

Since the two voltages are driven at different frequencies, suitable spectral techniques allow &1 and α₂ to be individually extracted from qₓ₁₄. In a case with a solid ground, C_{LGM} approaches infinity, and α₁=α₂=0. In an LGM situation, their ratio yields the following:

$$\frac{{α}_{1}}{{α}_{2}} = \frac{Δ {C}_{y 2}}{Δ {C}_{x 6}} \qquad ( 4 )$$

The finger signal is defined to be the transcapacitance. In both LGM and solid ground situations, a finger reduces the transcapacitance between a pair of crossing electrodes. By convention, this is inverted to produce a positive peak. However, the parasitic LGM signal increases the coupling as indicated in Equations 2 and 3. Thus, the inversion flips the sign which explains the negative peak for the LGM artifact in the transcapacitance profiles illustrated in FIG. 5 and FIG. 6.

It will be appreciated that the electrode voltages excite the finger-to-electrode couplings, ΔC_{y2} and ΔCₓ₆. The other sides of those two capacitors are tied to the LGM node. Further, since all other electrodes are grounded, the finger couplings to the remaining electrodes are modeled as capacitors between the LGM node and ground.

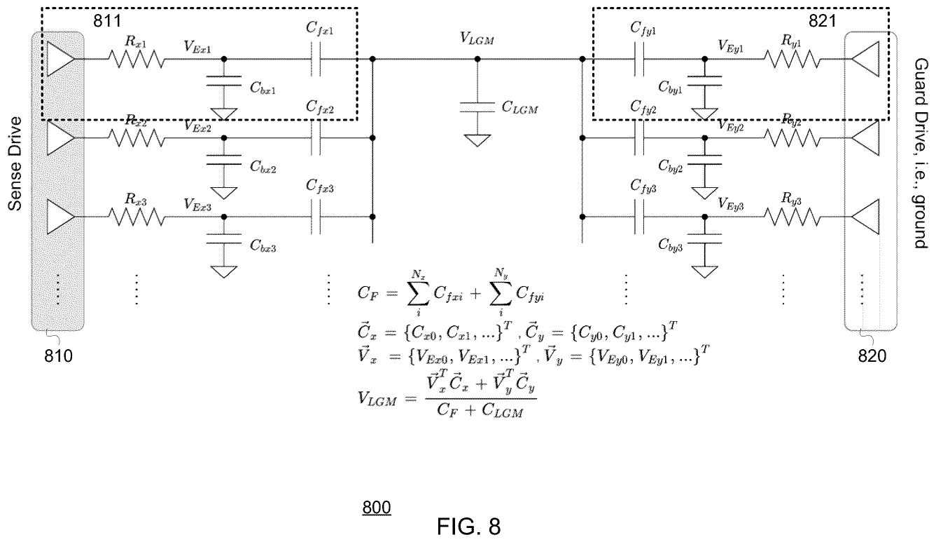

FIG. 8 illustrates one of various examples of a generalized circuit model 800 of a touch sensor device. Driver 810 may generate one or more electrode voltages. Circuit 811 may generate a first electrode voltage.

Driver 820 may represent a model of the ground voltage at each electrode. Circuit 821 may represent a model of the ground circuit for a first electrode.

The LGM voltage V_{LGM} depends only on the electrode voltages.

Returning to FIG. 2, in an exemplary embodiment, one of the fingers is driven with two frequencies on a pair of orthogonal electrodes. One frequency is for an optimal horizontal electrode passing beneath the chosen finger, while the other frequency is for an optimal vertical electrode passing beneath the chosen finger. FIG. 2 illustrates the case where finger F₁ is chosen. In this example, an electrode (x₁₄) passing beneath the other finger, F₂, measures not only a desired response (s₂), but two parasitic responses due to the first finger. The first parasitic response, α₁, is associated with ω₁ while the other, α₂, is associated with ω₂. The parasitic artifact associated with ω₂ is a cis-capacitance measurement of the LGM effect. Relationships between α₁ and α₂ can be established by examining the profiles obtained from transcapacitance X→Y and Y→X scans (as shown in FIGS. 5-6).

FIG. 3 illustrates 2 fingers situated diagonally. For this, two electrodes are stimulated on one axis and the response is measured on the orthogonal axis. The signal terms appear in s₁ and s₂ and the parasitic LGM terms in a and ω₂.

FIG. 4 shows the same 2 fingers use case as FIG. 3, but the sensor stimulation follows FIG. 2. One of the fingers (F₁) is driven simultaneously with a horizontal and vertical electrode while the response is measured for the other finger (F₂). Since F₂ touches neither of the stimulated electrodes, anything measured on electrode x₁₄ is due to parasitic LGM artifacts.

The LGM parameters associated with the two frequencies in the above examples depend on the finger sizes and specifically the capacitive couplings between the finger signal and the excitation electrodes.

For purposes of illustration and not limitation, the finger locations have been conveniently contrived to ensure ω₂ stimulates one finger but not the other. However, this is not required. As illustrated and described above in connection with FIGS. 5-7, the principles herein are also applicable more generally, such that α₁ and α₂ can be determined even when the input objects (e.g., F₁ and F₂) are arranged such that multiple objects overlap on a single stimulated electrode.

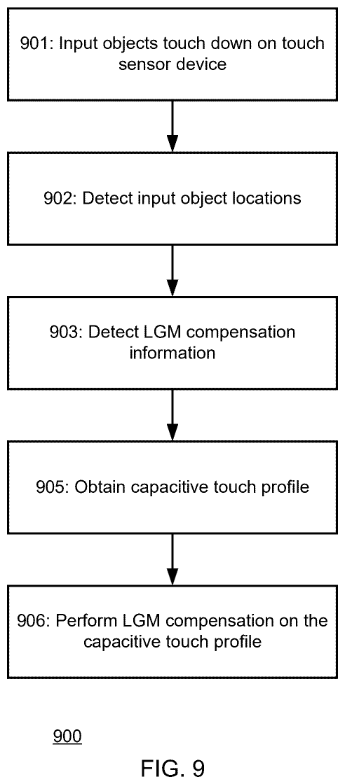

FIG. 9 illustrates an example of a flowchart corresponding to a process for capacitive sensing according to an exemplary embodiment of the present application. At stage 901, input objects (such as two or more fingers of a user) touch down on or near a capacitive touch sensor device. At stage 902, the locations of the input objects are detected. Stage 902 may include a coarse location detection process, for example, using a low-resolution scan using groups of electrodes. Examples of ways to detect the locations of input objects are described in U.S. Patent Publication 2025/0208729, titled “ADAPTIVE SCANNING USING CAPACITIVE SENSORS,” the contents of which are incorporated by reference herein in their entirety.

At stage 903, LGM compensation information is detected, for example, in accordance with the process shown and described in connection with FIG. 2 above, FIG. 3 above, FIG. 4 above, and/or FIGS. 5-6 above. In particular, a subset of selected transmitter electrodes are driven with sensing signals at different frequencies, and resulting signals are obtained via a selected subset of receiver electrodes, wherein the selection of the transmitter electrodes and receiver electrode(s) is based on the detected locations from stage 902.

For example, in accordance with FIGS. 2 and 4, one horizontal electrode and one vertical electrode (corresponding to the location of a first input object) are driven simultaneously at different frequencies, and resulting signals are obtained via another vertical electrode (corresponding to the location of a second input object).

For example, in accordance with FIG. 3, two horizontal electrodes (corresponding to the respective locations of two input objects) are driven simultaneously at different frequencies, and resulting signals are obtained via two vertical electrodes (corresponding to the respective locations of two input objects).

For example, in accordance with FIGS. 5-6, one horizontal electrode (corresponding to the location of a first input object) is driven with a first frequency with resulting signals being obtained via all vertical electrodes (to obtain a 1D horizontal capacitive profile), followed by one vertical electrode (also corresponding to the location of the first input object) being driven with a second frequency with resulting signals being obtained via all horizontal electrodes (to obtain a 1D vertical capacitive touch profile).

At stage 905, a 2D capacitive touch profile is obtained. The 2D capacitive touch profile may be obtained via one or more subsets of electrodes for just the regions proximate to the input object locations, as described in U.S. Patent Publication 2025/0208729 referenced above, or the 2D capacitive touch profile may be obtained for an entire sensing region of the capacitive touch sensor device using all electrodes of both axes of the sensing region.

At stage 906, LGM compensation is performed on the capacitive touch profile by a processing system of the touch sensor device using the LGM compensation information obtained at stage 903.

It will be appreciated that the process 900 shown in FIG. 9 is merely exemplary, and that the different stages may be performed in another order without departing from the principles discussed herein.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Exemplary embodiments are described herein. Variations of those exemplary embodiments may become apparent to those of ordinary skill in the art upon reading the foregoing description. It is understood that skilled artisans are able to employ such variations as appropriate, and the invention may be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A system for capacitive touch sensing, comprising:
a plurality of electrodes corresponding to a sensing region; and
a processing system configured to:
detect low ground mass (LGM) compensation information based on multiple input objects being present in the sensing region, wherein detecting the LGM compensation information comprises:
driving a first transmitter electrode of the plurality of electrodes with a first sensing signal having a first frequency and a second transmitter electrode of the plurality of electrodes with a second sensing signal having a second frequency different from the first frequency; and
obtaining resulting signals based on the first and second sensing signals having the first and second frequencies via at least one receiver electrode of the plurality of electrodes;
obtain a two-dimensional capacitive touch profile for the multiple input objects in the sensing region; and
perform LGM compensation on the two-dimensional capacitive touch profile using the detected LGM compensation information.

2. The system according to claim 1, wherein the processing system is further configured to:
before detecting the LGM compensation information, detect locations of the multiple input objects.

3. The system according to claim 2, wherein the processing system is further configured to:
select the first and second transmitter electrodes out of the plurality of electrodes based on the detected locations of the multiple input objects.

4. The system according to claim 1, wherein the first transmitter electrode is an electrode of a first axis of the sensing region and the second transmitter electrode is a first electrode of a second axis of the sensing region;
wherein an intersection between the first and second transmitter electrodes corresponds to a location of a first input object of the multiple input objects;
wherein the at least one receiver electrode comprises a first receiver electrode, wherein the first receiver electrode is a second electrode of the second axis of the sensing region; and
wherein an intersection between the first transmitter electrode and the first receiver electrode corresponds to a location of a second input object of the multiple input objects.

5. The system according to claim 4, wherein the processing system is configured to drive the first and second transmitter electrodes with the first and second sensing signals simultaneously.

6. The system according to claim 1, wherein the first transmitter electrode is a first electrode of a first axis of the sensing region and the second transmitter electrode is a second electrode of the first axis of the sensing region;
wherein the at least one receiver electrode comprises a first receiver electrode and a second receiver electrode, wherein the first receiver electrode is a first electrode of a second axis of the sensing region, and wherein the second receiver electrode is a second electrode of the second axis of the sensing region;
wherein an intersection between the first receiver electrode and the first transmitter electrode corresponds to a location of a first input object of the multiple input objects; and
wherein an intersection between the second transmitter electrode and the second receiver electrode corresponds to a location of a second input object of the multiple input objects.

7. The system according to claim 6, wherein the processing system is configured to drive the first and second transmitter electrodes with the first and second sensing signals simultaneously.

8. The system according to claim 1, wherein the first transmitter electrode is an electrode of a first axis of the sensing region and the second transmitter electrode is a first electrode of a second axis of the sensing region;
wherein an intersection between the first and second transmitter electrodes corresponds to a location of a first input object of the multiple input objects;
wherein the at least one receiver electrode comprises a receiver electrode, wherein the receiver electrode is a second electrode of the second axis of the sensing region; and
wherein the receiver electrode corresponds to a location of a second input object of the multiple input objects.

9. The system according to claim 8, wherein the processing system is configured to drive the first and second transmitter electrodes with the first and second sensing signals simultaneously.

10. The system according to claim 1, wherein the first transmitter electrode is an electrode of a first axis of the sensing region and the second transmitter electrode is a first electrode of a second axis of the sensing region;
wherein the processing system is configured to drive the first and second transmitter electrodes with the first and second sensing signals at different times;
wherein, while the first transmitter electrode is being driven with the first sensing signal, a plurality of electrodes of the second axis of the sensing region are operated as receiver electrodes; and
wherein, while the second transmitter electrode is being driven with the second sensing signal, a plurality of electrodes of the first axis of the sensing region are operated as receiver electrodes.

11. The system according to claim 1, wherein the two-dimensional capacitive touch profile is a two-dimensional capacitive image of an entire sensing region.

12. The system according to claim 1, wherein the two-dimensional capacitive touch profile does not include a two-dimensional capacitive image of an entire sensing region; and
wherein the two-dimensional capacitive touch profile comprises two-dimensional capacitive images of a first subset of the sensing region corresponding to a first input object of the multiple input objects and of a second subset of the sensing region corresponding to a second input object of the multiple input objects.

13. A method for capacitive touch sensing, comprising:
detecting, by a processing system, using a plurality of electrodes corresponding to a sensing region, low ground mass (LGM) compensation information based on multiple input objects being present in the sensing region, wherein detecting the LGM compensation information comprises:
driving a first transmitter electrode of the plurality of electrodes with a first sensing signal having a first frequency and a second transmitter electrode of the plurality of electrodes with a second sensing signal having a second frequency different from the first frequency; and
obtaining resulting signals based on the first and second sensing signals having the first and second frequencies via at least one receiver electrode of the plurality of electrodes;
obtaining, by the processing system, a two-dimensional capacitive touch profile for the multiple input objects in the sensing region; and
performing, by the processing system, LGM compensation on the two-dimensional capacitive touch profile using the detected LGM compensation information.

14. The method according to claim 13, further comprising:
before detecting the LGM compensation information, detecting, by the processing system, locations of the multiple input objects.

15. The method according to claim 13, further comprising:
selecting, by the processing system, the first and second transmitter electrodes out of the plurality of electrodes based on the detected locations of the multiple input objects.

16. The method according to claim 13, wherein the first transmitter electrode is an electrode of a first axis of the sensing region and the second transmitter electrode is a first electrode of a second axis of the sensing region;
wherein an intersection between the first and second transmitter electrodes corresponds to a location of a first input object of the multiple input objects;
wherein the at least one receiver electrode comprises a first receiver electrode, wherein the first receiver electrode is a second electrode of the second axis of the sensing region; and
wherein an intersection between the first transmitter electrode and the first receiver electrode corresponds to a location of a second input object of the multiple input objects.

17. The method according to claim 13, wherein the first transmitter electrode is a first electrode of a first axis of the sensing region and the second transmitter electrode is a second electrode of the first axis of the sensing region;
wherein the at least one receiver electrode comprises a first receiver electrode and a second receiver electrode, wherein the first receiver electrode is a first electrode of a second axis of the sensing region, and wherein the second receiver electrode is a second electrode of the second axis of the sensing region;
wherein an intersection between the first receiver electrode and the first transmitter electrode corresponds to a location of a first input object of the multiple input objects; and
wherein an intersection between the second transmitter electrode and the second receiver electrode corresponds to a location of a second input object of the multiple input objects.

18. The method according to claim 13, wherein the first transmitter electrode is an electrode of a first axis of the sensing region and the second transmitter electrode is a first electrode of a second axis of the sensing region;
wherein an intersection between the first and second transmitter electrodes corresponds to a location of a first input object of the multiple input objects;
wherein the at least one receiver electrode comprises a receiver electrode, wherein the receiver electrode is a second electrode of the second axis of the sensing region; and
wherein the receiver electrode corresponds to a location of a second input object of the multiple input objects.

19. The method according to claim 13, wherein the first transmitter electrode is an electrode of a first axis of the sensing region and the second transmitter electrode is a first electrode of a second axis of the sensing region;
wherein the processing system is configured to drive the first and second transmitter electrodes with the first and second sensing signals at different times;
wherein, while the first transmitter electrode is being driven with the first sensing signal, a plurality of electrodes of the second axis of the sensing region are operated as receiver electrodes; and
wherein, while the second transmitter electrode is being driven with the second sensing signal, a plurality of electrodes of the first axis of the sensing region are operated as receiver electrodes.

20. A non-transitory computer-readable medium having processor-executable instructions stored thereon for capacitive touch sensing, wherein the processor-executable instructions, when executed, facilitate performance of the following:
detecting, by a processing system, using a plurality of electrodes corresponding to a sensing region, low ground mass (LGM) compensation information based on multiple input objects being present in the sensing region, wherein detecting the LGM compensation information comprises:
driving a first transmitter electrode of the plurality of electrodes with a first sensing signal having a first frequency and a second transmitter electrode of the plurality of electrodes with a second sensing signal having a second frequency different from the first frequency; and
obtaining resulting signals based on the first and second sensing signals having the first and second frequencies via at least one receiver electrode of the plurality of electrodes;
obtaining, by the processing system, a two-dimensional capacitive touch profile for the multiple input objects in the sensing region; and
performing, by the processing system, LGM compensation on the two-dimensional capacitive touch profile using the detected LGM compensation information.
